(19) United States
(12) Patent Application Publication
(10) Pub. No.: US 2020/0136208 A1
(43) Pub. Date: Apr. 30, 2020

(54) LITHIUM-ION SOFT BATTERY

(71) Applicant: CHANGSHA JUNENGCHONG NEW ENERGY CO., LTD, Changsha (CN)

(72) Inventor: BO-QIAN QIU, Changsha (CN)

(21) Appl. No.: 16/727,692

(22) Filed: Dec. 26, 2019

Related U.S. Application Data
(63) Continuation of application No. PCT/CN2018/093104, filed on Jun. 27, 2018.

(30) Foreign Application Priority Data
Jun. 28, 2017 (CN) 201710503413.5
Jun. 28, 2017 (CN) 201710503427.7

(51) Int. Cl. H01M 10/654; H01M 10/0525; H01M 10/625; H01M 10/6552; H01M 10/617; H01M 10/6551; H01M 10/658; H01M 10/6556; H01M 10/6567; H01M 10/48

(52) U.S. Cl. CPC H01M 10/654; H01M 10/0525; H01M 10/625; H01M 10/6552; H01M 10/617; H01M 2220/20; H01M 10/658; H01M 10/6556; H01M 10/6567; H01M 10/486; H01M 10/6551

(57) ABSTRACT

A lithium-ion soft battery which can maintain within a certain range includes a battery cell having a positive electrode plate and a negative electrode plate. The negative electrode plate includes a negative current collector and a negative active material layer on the negative current collector. The positive electrode plate includes a positive current collector and a positive active material layer on the positive current collector. The positive electrode plate and/or the negative electrode plate includes a heat conducting and collecting body, which is a portion of the positive current collector not coated by the positive active material layer or a portion of the negative current collector not coated by the negative active material layer. At least two heat conducting and collecting bodies are stacked together to form at least one heat converging path. A fluid-containing pipe is connected to the heat converging path.

### CROSS-REFERENCE TO RELATED APPLICATIONS

This application claims all benefits accruing under 35 U.S.C. § 119 from China Patent Application No. 201710503413.5, filed on Jun. 28, 2017 and China Patent Application No. 201710503427.7, filed on Jun. 28, 2017, in the China National Intellectual Property Administration, the content of which is hereby incorporated by reference. This application is a continuation under 35 U.S.C. § 120 of international patent application PCT/CN2018/093104 filed Jun. 27, 2018.

### FIELD

The subject matter herein generally relates to lithium-ion batteries, and more particularly, to a lithium-ion soft battery.

### BACKGROUND

Traffic on the roads adds pressure on the energy consumption and environmental pollution, thus it is urgent to develop and research efficient, clean and safe new energy sources for vehicles to achieve energy conservation and emission reduction. Lithium-ion batteries have become the best candidates for power systems of the new energy sources for vehicles because of the high specific energy, extremely low pollution of lithium-ion batteries. However, the lithium-ion batteries are very sensitive to temperature, and efficient discharge and good performance of the battery pack can be only obtained within a suitable temperature range. Operating at an elevated temperature may cause the lithium-ion battery to age faster and increase its thermal resistances faster. Furthermore, the cycling time becomes less, the service life becomes shorter, and even thermal runaway problems occur at an elevated operating temperature. However, operating at too low a temperature may lower the conductivity of the electrolyte and the ability to conduct active ions, resulting an increase of the impedance, and a decrease in the capacity of the lithium-ion batteries.

Conventionally, the cell is positioned to improve the fluid flow path and increase the heat dissipation. The battery casing may also be improved by replacing the aluminum alloy shell material with the composite of thermoelectric material and aluminum, and by adding a plurality of heat dissipating ribs to the side of the battery casing. The electrode plate may also be extended into the electrolyte to transmit heat energy to the battery casing through the electrolyte and then to the outside environment. Although some heat is dissipated, the heat dissipation efficiency is generally low because the heat cannot be directly discharged from the electrode plates, the main heat generating component, to the outside environment. Therefore, a new design of a lithium-ion soft battery is desired.

### BRIEF DESCRIPTION OF THE DRAWINGS

FIG. 1 is a schematic view of a lithium-ion soft battery in a first embodiment according to the present disclosure.

FIG. 2A is a cross-sectional view of the lithium-ion soft battery of FIG. 1.

FIG. 2B is a cross-sectional view of a positive electrode plate of the lithium-ion soft battery of FIG. 2A.

FIG. 2C is a cross-sectional view of a negative electrode plate of the lithium-ion soft battery of FIG. 2A.

FIG. 3 is a schematic view of a lithium-ion soft battery in a second embodiment according to the present disclosure.

FIG. 4 is a cross-sectional view of the lithium-ion soft battery of FIG. 3.

FIG. 5 is a schematic view of a lithium-ion soft battery in a third embodiment according to the present disclosure.

FIG. 6 is a schematic view of a lithium-ion soft battery in a fourth embodiment according to the present disclosure.

FIG. 7 is a schematic view of a lithium-ion soft battery in a fifth embodiment according to the present disclosure.

FIG. 8 is a schematic view of a lithium-ion soft battery in a sixth embodiment according to the present disclosure.

FIG. 9 is a schematic view of a lithium-ion soft battery in a seventh embodiment according to the present disclosure.

FIG. 10 is a cross-sectional view of the lithium-ion soft battery of FIG. 9.

FIG. 11 is a schematic view of a lithium-ion soft battery in an eighth embodiment according to the present disclosure.

FIG. 12 is a cross-sectional view of the lithium-ion soft battery of FIG. 11.

FIG. 13 is a schematic view of a lithium-ion soft battery in a ninth embodiment according to the present disclosure.

FIG. 14 is a cross-sectional view of the lithium-ion soft battery of FIG. 13.

FIG. 15 is a schematic view of a lithium-ion soft battery in a tenth embodiment according to the present disclosure.

FIG. 16 is a schematic view of a lithium-ion soft battery in an eleventh embodiment according to the present disclosure.

FIG. 17 is a schematic view of a lithium-ion soft battery in a twelfth embodiment according to the present disclosure.

### DETAILED DESCRIPTION

Implementations of the disclosure will now be described, by way of embodiments only, with reference to the drawings.

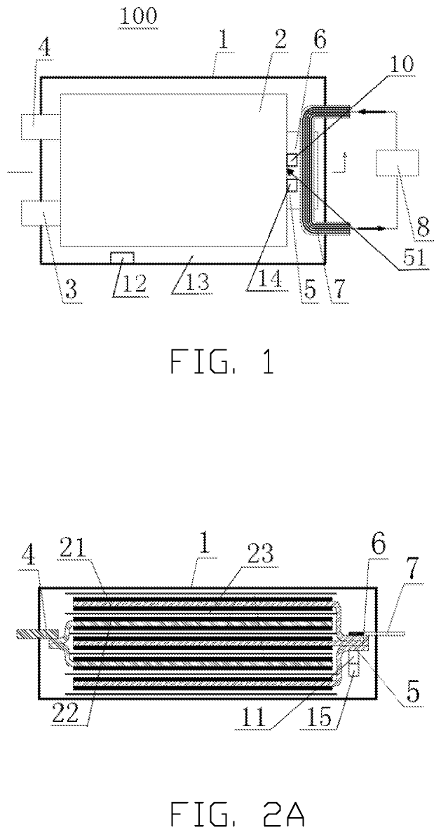

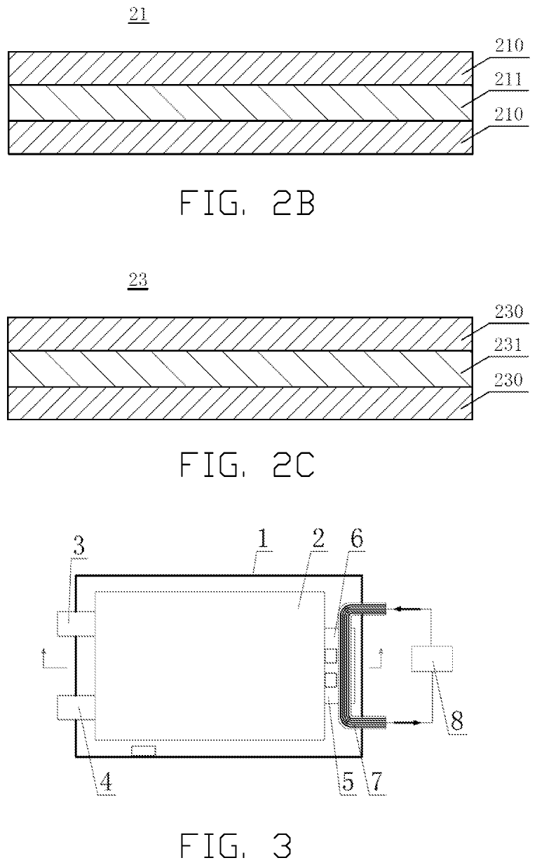

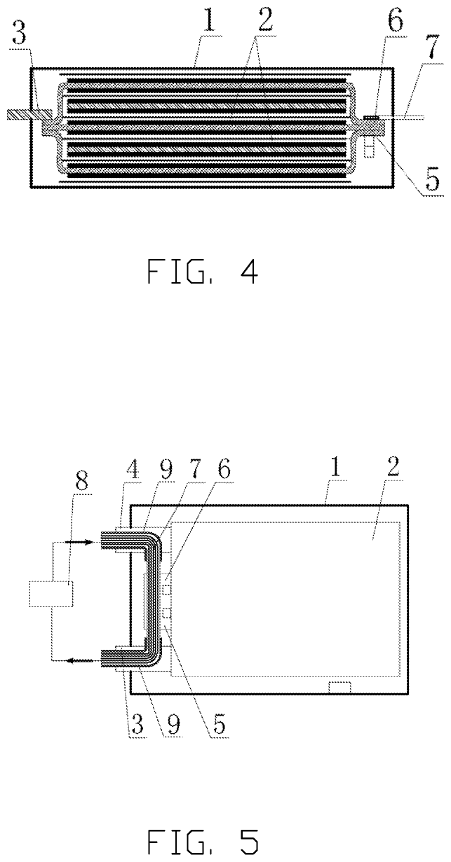

FIGS. 1 and 2A illustrate a first embodiment of a lithium-ion soft battery 100 comprising a package bag 1, a positive electrode tab 3, a negative electrode tab 4, and a battery cell 2 received in the package bag 1. The positive electrode tab 3 and the negative electrode tab 4 protrude from the package bag 1. The battery cell 2 comprises a positive electrode plate 21, a negative electrode plate 23, and a separator 22 spaced between the positive electrode plate 21 and the negative electrode plate 23. The positive electrode plate 21, the separator 22, and the negative electrode plate 23 are sequentially laminated together and then wound together to form the battery cell 2. Referring to FIG. 2B, the positive electrode plate 21 comprises a positive current collector 211 and two positive active material layers 210 coated on the positive current collector 211. Referring to FIG. 2C, the negative electrode plate 23 comprises a negative current collector 231 and two negative active material layers 230 coated on the negative current collector 231.

Referring to FIGS. 1 and 2A, the lithium-ion soft battery 100 further comprises at least two heat conducting and collecting bodies 5 formed on at least one of the positive electrode plate 21 and the negative electrode plate 23. Each heat conducting and collecting body 5 is a portion of the positive current collector 211 not coated by the positive active material layer 210 or a portion of the negative current collector 231 not coated by the negative active material layer 230. The at least two heat conducting and collecting bodies 5 are stacked together to form at least one heat converging path 6, which is configured to transmit heat energy into or out of the battery cell 2. A fluid-containing pipe 7 is connected to the heat converging path 6.

In at least one embodiment, the fluid-containing pipe 7 can be a pipe containing air conditioning refrigerant. By stacking the heat conducting and collecting bodies 5 to form the heat converging path 6 and heating or cooling the heat converging path 6 through the air conditioning refrigerant, the internal temperature of the battery 100 is increased or decreased, thereby avoiding low working efficiency and low service life of the battery 100. The temperature of the battery 100 can be maintained within a suitable range, which can increase working efficiency and service life of the battery 100. Potential safety hazards can be avoided. The heat conducting and collecting body 5 can be integrally formed with the positive electrode plate, which simplifies the manufacturing process and increase the manufacturing efficiency.

In another embodiment, the fluid-containing pipe 7 can also be a heat pipe comprising a pipe casing and a wick structure disposed in the pipe casing. As such, the heat energy of the electrode plates, the main heat generating component, can be quickly converged on the heat converging path 6, and then exchanged between the heat converging path 6 and the heat pipe. When the internal temperature of the battery 100 is too low, the battery 100 can also be heated by the heat pipe. Thus, the electrode plates of the battery 100 can work under the suitable temperature, and the battery 100 can maintain in a best state for charging and discharging. The capacity fading is restrained, and the service life of the battery 100 is increased.

In at least one embodiment, the heat conducting and collecting bodies 5 overlap with each other. The heat conducting and collecting bodies 5 are connected together by welding, thereby forming the heat converging path 6. That is, the heat conducting and collecting bodies 5 can be connected together without any extra component. The welding can be ultrasonic welding, laser welding, or friction welding. In another embodiment, the heat conducting and collecting bodies 5 can also be connected together by bolting or riveting.

Moreover, referring to FIG. 2A, the heat conducting and collecting bodies 5 are bent towards each other before connected together. Therefore, the heat absorbed by the heat conducting and collecting bodies 5 is converged, which facilitates dissipating of the heat from the battery 100 or heating of the battery 100. The heat conducting and collecting bodies 5 are bent to be perpendicular to the positive electrode plate 21 or the negative electrode plate 23. The heat conducting and collecting bodies 5 can also be bent to be inclined with the positive electrode plate 21 or the negative electrode plate 23 by an angle between 0 degree to 89 degrees. The heat conducting and collecting bodies 5 can be bent toward different directions (for example, the bending direction of a portion of the heat conducting and collecting bodies 5 being opposite to that of the remaining heat conducting and collecting bodies 5). The entirety of the heat conducting and collecting bodies 5 can also be bent toward a single direction, which facilitates the connection of the heat conducting and collecting bodies 5. In other embodiments, a portion of the heat conducting and collecting bodies 5 are bent toward a single direction or different directions, and the portion which is bent is connected to the remaining portion of the heat conducting and collecting bodies 5, the remaining portion of each of the heat conducting and collecting bodies 5 is straight (unbent).

In other embodiments, the heat conducting and collecting bodies 5 can also be parallel to the positive active material layers 210. That is, the heat conducting and collecting bodies 5 are not bent towards each other.

In at least one embodiment, the heat converging path 6 (fluid-containing pipe 7) can be disposed at an end of the battery 100 having the positive terminal tab 3 or opposite to the positive terminal tab 3. The heat converging path 6 can also be disposed at a side of the battery 100. When the number of the at least one heat converging paths 6 is greater than one, the heat converging paths 6 disposed at the end of the positive terminal tab 3 can be one or more than one.

Referring to FIGS. 1 and 2, the positive electrode tab 3 and the negative electrode tab 4 are disposed at the same end of the battery 100. The heat conducting and collecting bodies 5 are disposed at the opposite end of the battery 100, and are connected to the negative electrode tab 4. The inlet and the outlet of the fluid-containing pipe 7 are further connected to a first heat exchanging device 8 outside the battery 100.

Referring to FIG. 3, in a second embodiment, the positive electrode tab 3 and the negative electrode tab 4 are disposed at the same end of the battery 100. The heat conducting and collecting bodies 5 are disposed at the opposite end of the battery 100, and are connected to the positive electrode tab 3.

Referring to FIG. 5, in a third embodiment, the positive electrode tab 3, the negative electrode tab 4, and the heat conducting and collecting bodies 5 are disposed at the same end of the battery 100. An inlet section of the fluid-containing pipe 7 is disposed on the negative electrode tab 4, and an outlet section of the fluid-containing pipe 7 is disposed on the positive electrode tab 3. Both the inlet section and the outlet section of the fluid-containing pipe 7 are surrounded by a first insulating layer 9. The first insulating layer 9 isolates the fluid-containing pipe 7 from the positive and the negative electrode tabs 3, 4.

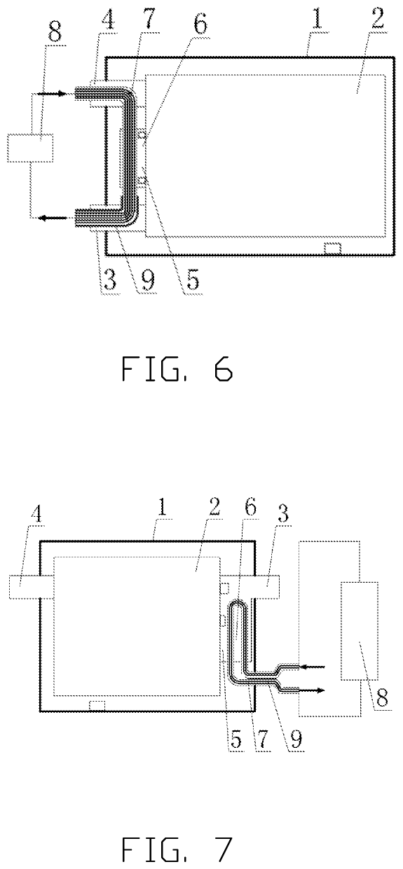

Referring to FIG. 6, in a fourth embodiment, the positive electrode tab 3, the negative electrode tab 4, and the heat conducting and collecting bodies 5 are disposed at the same end of the battery 100. The inlet section of the fluid-containing pipe 7 is disposed on the negative electrode tab 4, and the outlet section of the fluid-containing pipe 7 is disposed on the positive electrode tab 3. Only the outlet section of the fluid-containing pipe 7 is surrounded by the first insulating layer 9.

Referring to FIG. 7, in a fifth embodiment, the positive electrode tab 3 and the negative electrode tab 4 are disposed at opposite ends of the battery 100. The heat conducting and collecting bodies 5 is disposed on and connected to the positive electrode tab 3. Both the inlet section and the outlet section of the fluid-containing pipe 7 are disposed at a same position of the package bag 1, and are surrounded by the first insulating layer 9. The first insulating layer 9 isolates the fluid-containing pipe 7 from the positive and the negative electrode tabs 3, 4, and can also isolate the heat energy.

Referring to FIG. 8, in a sixth embodiment, the positive electrode tab 3 and the negative electrode tab 4 are disposed at the same end of the battery 100. The heat conducting and collecting bodies 5 are disposed at the opposite end of the battery 100, and are connected to the positive electrode tab 3. Both the inlet section and the outlet section of the fluid-containing pipe 7 are disposed at a same position of the package bag 1, and are surrounded by the first insulating layer 9.

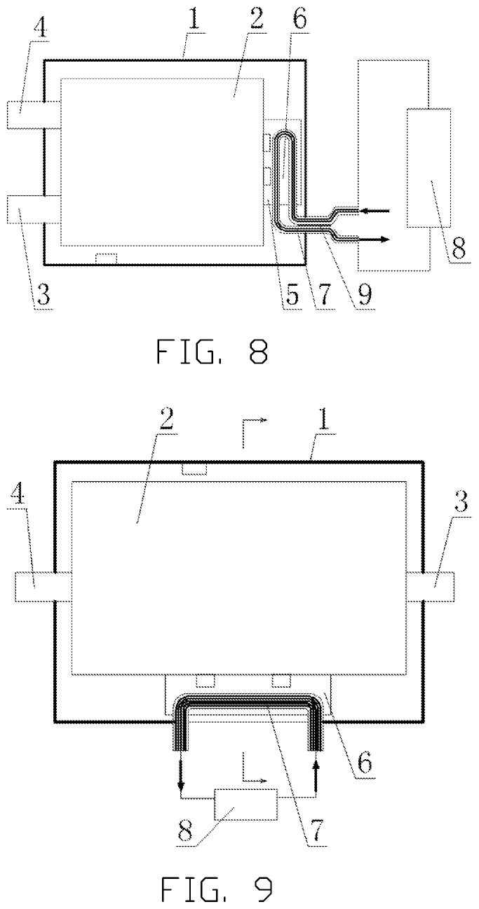

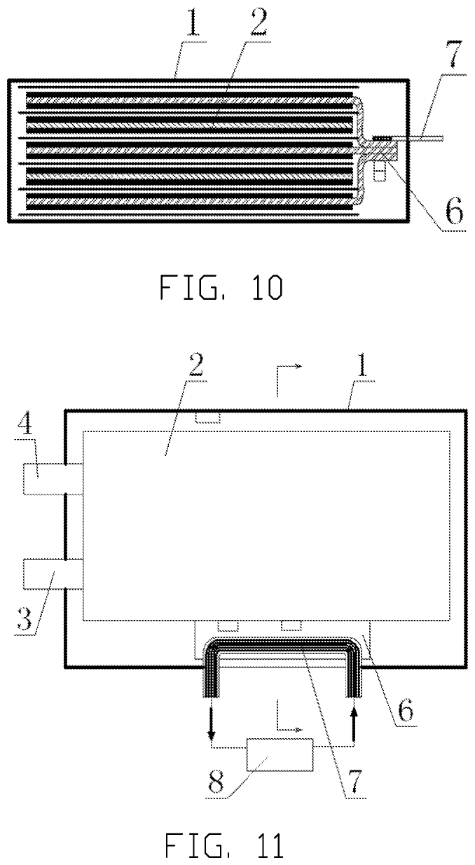

Referring to FIGS. 9 and 10, in a seventh embodiment, the positive electrode tab 3 and the negative electrode tab 4 are disposed at opposite ends of the battery 100. The inlet section and the outlet section of the fluid-containing pipe 7 are disposed at different positions of the package bag 1.

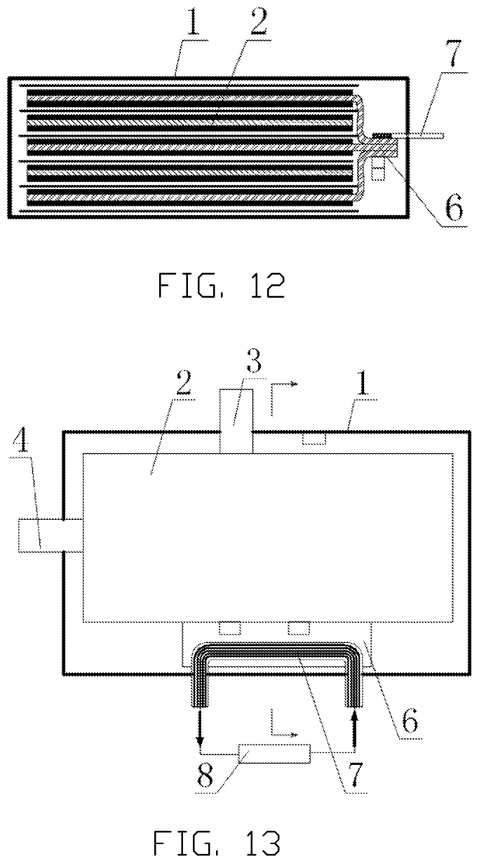

Referring to FIGS. 11 and 12, in an eighth embodiment, the positive electrode tab 3 and the negative electrode tab 4 are disposed at the same end of the battery 100. The heat conducting and collecting bodies 5 are disposed at the side of the battery 100. The inlet section and the outlet section of the fluid-containing pipe 7 are disposed at different positions of the package bag 1.

Referring to FIGS. 13 and 14, in a ninth embodiment, the positive electrode tab 3 and the negative electrode tab 4 are respectively disposed at an end and a side of the battery 100. The heat conducting and collecting bodies 5 are disposed at another side of the battery 100 opposite to the positive electrode tab 3. The inlet section and the outlet section of the fluid-containing pipe 7 are disposed at different positions of the battery 100.

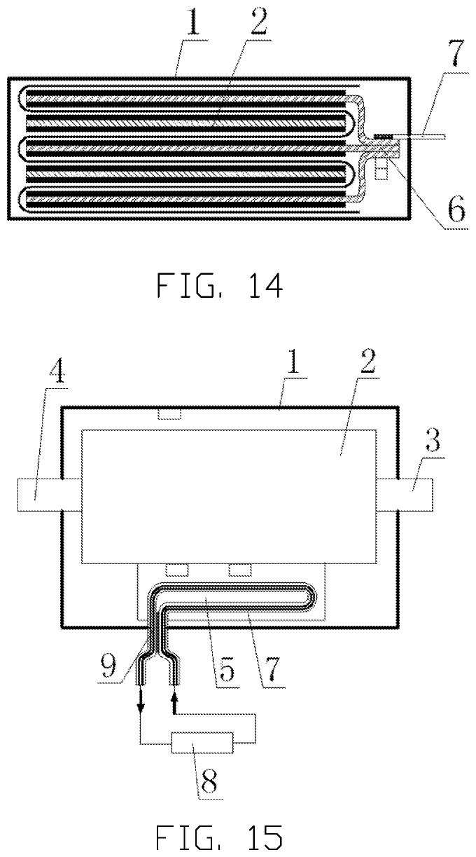

Referring to FIG. 15, in a tenth embodiment, the positive electrode tab 3 and the negative electrode tab 4 are disposed at opposite ends of the battery 100. The heat conducting and collecting bodies 5 are disposed at the side of the battery 100, and are connected to the positive electrode tab 3. Both the inlet section and the outlet section of the fluid-containing pipe 7 are disposed at the same position of the battery 100, and are surrounded by the first insulating layer 9.

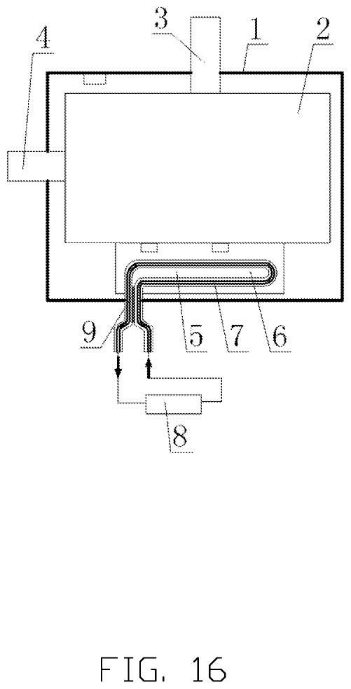

Referring to FIG. 16, in an eleventh embodiment, the positive electrode tab 3 and the negative electrode tab 4 are respectively disposed at an end and a side of the battery 100. The heat conducting and collecting bodies 5 are disposed at another side of the battery 100 opposite to the positive electrode tab 3. Both the inlet section and the outlet section of the fluid-containing pipe 7 are disposed at the same position of the battery 100, and are surrounded by the first insulating layer 9.

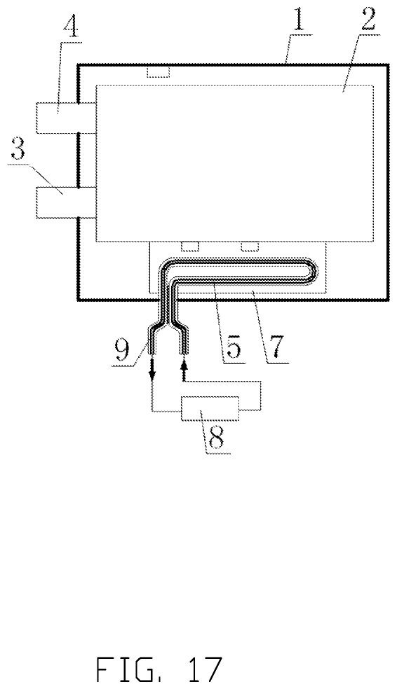

Referring to FIG. 17, in a twelfth embodiment, the positive electrode tab 3 and the negative electrode tab 4 are disposed at the same end of the battery 100. The heat conducting and collecting bodies 5 are disposed at the side of the battery 100, and are connected to the positive electrode tab 3. Both the inlet section and the outlet section of the fluid-containing pipe 7 are disposed at the same position of the battery 100, and are surrounded by the first insulating layer 9.

In at least one embodiment, at least a portion of the heat conducting and collecting bodies 5 defines a plurality of holes (not shown). The holes can pass through the heat conducting and collecting body 5, and have a mesh structure or a 3D internal structure. In another embodiment, at least a portion of the heat conducting and collecting bodies 5 can define a concave and convex surface. As such, the heat conducting performance of the heat conducting and collecting body 5 is improved.

Referring to FIG. 1, in at least one embodiment, a heat dissipation member 10 is connected to the heat converging path 6. The heat dissipation member 9 can be disposed between the heat conducting and collecting bodies 5. As such, the heat dissipation member 9 can conduct the heat energy out of the heat converging path 6. The heat dissipation member 9 can be multiple fins, a heat sink, or a metal sheet. The metal sheets can quickly conduct the heat energy out of the heat converging path 6. The metal sheet and the heat conducting and collecting body 5 can be made of a same material, which facilitates the connection between the metal sheet and the heat conducting and collecting body 5.

In at least one embodiment, a second heat exchanging device 11 is connected to the heat converging path 6 by welding. The second heat exchanging device 11 can maintain the temperature of the heat converging path 6 within a suitable range, thereby avoiding damages to the battery 100. Furthermore, the heat converging path 6 and the second heat exchanging device 11 are connected together without any extra component, which also facilitates the connection. In another embodiment, the heat converging path 6 and the second heat exchanging device 11 can also be connected together by bolting, gluing, or riveting, which allows the connection to be stable.

In at least one embodiment, the heat conducting and collecting body 5 can have a second insulating layer (not shown) on a surface thereof. As such, a short circuit and an explosion of the battery 100 can be avoided.

In at least one embodiment, the heat conducting and collecting body 5 can protrude from the positive electrode plate 21, which facilitates the conduction and dissipation of the heat energy. Portions of the heat conducting and collecting body 5 protruding from the positive electrode plate 21 are further inserted into the electrolyte 13 received in the package bag 1. As such, the heat energy from the heat conducting and collecting body 5 can be conducted into the electrolyte 13 and further to the external surface of the battery 100. Therefore, the heat energy is prevented from being accumulated in the battery 100 due to poor heat conduction of the separator 22. Furthermore, the heat energy in the electrolyte 13 can further quickly move to the positive and the negative electrode plates 21, 23, which prevents the temperature of the positive and the negative electrode plates 21, 23 from being too low. In another embodiment, the heat conducting and collecting body 5 can also be recessed with respect to the negative electrode plate 23, which saves the internal space of the battery 100, and further increases the capacity of the battery 100 in casing of a certain size.

In at least one embodiment, a third heat exchanging device 12 is disposed in the electrolyte 13 for heating or cooling the electrolyte 13. The electrolyte 13 can in turn heat or cool the heat conducting and collecting bodies 5, thereby maintaining the temperature of the battery 100 within a suitable range.

In an embodiment, an interconnecting portion 51 is formed between the heat conducting and collecting body 5 and the negative electrode plate 23. A thickness of the entirety of the heat conducting and collecting body 5 is same of that of the interconnecting portion 51. As such, the heat conducting property of the heat conducting and collecting body 5 is improved, and the manufacturing process is simplified.

In at least one embodiment, a first temperature sensor 14 is disposed on the heat converging path 6, which can sense the temperature of the heat converging path 6. Furthermore, a second temperature sensor 15 is disposed on the second heat exchanging device 11, which can sense the temperature of the second heat exchanging device 11. The first and the second temperature sensors 14, 15 can be thin-film temperature sensors.

In at least one embodiment, the positive active material of the positive active material layer 210 is lithium iron phosphate, lithium cobalt oxide, lithium manganate, or a ternary material. The negative active material of the negative active material layers 230 is carbon, tin-based negative material, transition metal nitride containing lithium or alloy.

Implementations of the above disclosure will now be described by way of embodiments only. It should be noted that devices and structures not described in detail are understood to be implemented by the general equipment and methods available in the art.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lithium-ion soft battery comprising:
a battery cell comprising a positive electrode plate and a negative electrode plate, the negative electrode plate comprising a negative current collector and a negative active material layer coated on the negative current collector, the positive electrode plate comprising a positive current collector and a positive active material layer coated on the positive current collector; and
at least two heat conducting and collecting bodies formed on at least one of the positive electrode plate and the negative electrode plate, each of the heat conducting and collecting bodies being a portion of the positive current collector not coated by the positive active material layer or a portion of the negative current collector not coated by the negative active material layer;
wherein the at least two heat conducting and collecting bodies are stacked together to form at least one heat converging path, which being configured to transmit heat energy into or out of the battery cell; and
wherein a fluid-containing pipe is connected to the at least one heat converging path.

2. The lithium-ion soft battery of claim 1, wherein the fluid-containing pipe is a pipe containing air conditioning refrigerant or a heat pipe.

3. The lithium-ion soft battery of claim 1, wherein the at least two heat conducting and collecting bodies overlap with each other to form the at least one heat converging path.

4. The lithium-ion soft battery of claim 1, wherein the at least two heat conducting and collecting bodies are connected together by welding, bolting, or riveting.

5. The lithium-ion soft battery of claim 1, wherein the at least two heat conducting and collecting bodies are bent towards each other.

6. The lithium-ion soft battery of claim 5, wherein the at least two heat conducting and collecting bodies are bent to be inclined with the positive electrode plate or the negative electrode plate by an angle between 0 degree to 90 degrees.

7. The lithium-ion soft battery of claim 5, wherein the at least two heat conducting and collecting bodies are bent toward different directions or a single direction.

8. The lithium-ion soft battery of claim 1, wherein a portion of the heat conducting and collecting bodies are bent toward a single direction or different directions, and the portion which is bent is connected to a remaining portion of the at least two heat conducting and collecting bodies, the remaining portion of each of the heat conducting and collecting bodies is straight.

9. The lithium-ion soft battery of claim 1, wherein at least a portion of the at least two heat conducting and collecting bodies defines a plurality of holes or a concave and convex surface.

10. The lithium-ion soft battery of claim 1, wherein a heat dissipation member is disposed between the at least two heat conducting and collecting bodies, and the heat dissipation member is fins or a heat sink.

11. The lithium-ion soft battery of claim 1, wherein a heat exchanging device is connected to the at least one heat converging path, and a temperature sensor is disposed on the heat exchanging device.

12. The lithium-ion soft battery of claim 11, wherein the at least one heat converging path and the heat exchanging device are connected by welding, bolting, gluing, or riveting.

13. The lithium-ion soft battery of claim 1, wherein each of the at least two heat conducting and collecting bodies comprises an insulating layer on a surface thereof.

14. The lithium-ion soft battery of claim 1, wherein the at least one heat converging path is disposed at an end of the lithium-ion soft battery, and the end of the lithium-ion soft battery having a positive electrode tab, an end of the lithium-ion soft battery opposite to the positive electrode tab, or a side of the lithium-ion soft battery.

15. The lithium-ion soft battery of claim 14, wherein when the at least one heat converging path is more than one, at least one of the heat converging paths is disposed at the end of the lithium-ion soft battery having the positive electrode tab.

16. The lithium-ion soft battery of claim 1, wherein each of the at least two heat conducting and collecting bodies protrudes from the positive electrode plate, and portions of the at least two heat conducting and collecting bodies which protrude from the positive electrode plate are inserted into an electrolyte of the lithium-ion soft battery.

17. The lithium-ion soft battery of claim 1, wherein a heat exchanging device is disposed in an electrolyte of the lithium-ion soft battery for heating or cooling the electrolyte.

18. The lithium-ion soft battery of claim 1, wherein the at least two heat conducting and collecting bodies are recessed with respect to the negative electrode plate, an interconnecting portion is formed between the at least two heat conducting and collecting bodies and the negative electrode plate, a thickness of an entirety of each of the at least two heat conducting and collecting bodies is same as of a thickness of the interconnecting portion.

19. The lithium-ion soft battery of claim 1, wherein a temperature sensor is disposed on the at least one heat converging path.
